(19) United States
(12) Patent Application Publication
(10) Pub. No.: US 2006/0214516 A1
(43) Pub. Date: Sep. 28, 2006

(54) 2-Dimensional displacement device

(75) Inventor: Gerardus Lucien Mathildus Jansen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/566,508

(22) PCT Filed: Jul. 27, 2004
(86) PCT No.: PCT/IB04/51298

§ 371 Date: Jan. 30, 2006

(30) Foreign Application Priority Data
Aug. 1, 2003 (EP) 03102400.3

(51) Int. Cl. H02K 41/00

(52) U.S. Cl. 310/12

(57) ABSTRACT

The invention relates to a displacement device (1, 31) provided with a first part (3, 33) with a primary coil (4, 34) and a second part (9, 39) with a secondary coil (10, 40), whereby the secondary coil (10, 40) can be moved in relation to the primary coil (4, 34) and is electrically connected to driving circuit. Once of the coils (4, 34) is an elongated coil, which extends in a travel direction, while the other coil (10, 40) can be moved in relation to the first coil (4, 34) in the travel direction.

The invention relates to a displacement device provided with a first part with a primary coil and a second part which can be moved in relation to the first part, the second part being provided with a secondary coil which can be moved in relation to the primary coil and which is electrically connected to an electrically driven element.

A displacement device of the kind is disclosed in United States patent U.S. Pat. No. 5,712,552. This known displacement device comprises a first stationary part and a second part which can be rotated in relation to the first part. Both parts are provided with annular coils which are facing each other, energy transfer taking place with the aid of the coils from the stationary primary coil which is connected to the first par, to the rotating secondary coil which is connected to the second part. The electrical energy generated in the secondary coil is subsequently transferred to the motors, detectors, sensors etc. which are located on the second part by means of electrical conductors.

By transferring electrical energy by means of high-frequency electromagnetic induction between the primary and the secondary coil, no electrically conducting wires are necessary between the first stationary part and the rotating second part. The advantage is that no wear of electrically conducting wires will take place. Moreover, said electrically conducting wires could disturb the movement of the second part in relation to the first part. Furthermore, said electrically conducting wires take up space inside the displacement device which, as a consequence, cannot be used for other purposes.

A drawback of the known displacement device is that it is limited to a rotating movement of the second part in relation to the first part.

It is an object of the present invention to provide a displacement device which permits translating movements.

This object is achieved by the displacement device according to the invention in that at least one of the coils is an elongated coil, which extends in a travel direction and in that the other coil can be moved in the travel direction in relation to the first coil.

The elongated coil, which extends in a travel direction, permits the other coil to be moved in the travel direction in relation to the first coil while the energy transfer during the movement remains ensured.

A preferred embodiment of the displacement device according to the invention is characterized in that the primary coil is the elongated coil and in that the secondary coil is located inside the primary coil.

By arranging the primary coil, which is connected to the first preferably stationary part as an elongated coil, and by locating the secondary coil, which is connected to the moveable second part, inside the primary coil, the secondary coil can be relatively compact so that the weight of the moveable second part is not adversely affected.

A further embodiment of the displacement device according to the invention is characterized in that a core extends through the coils transversely to the travel direction.

The elongated core, which extends transversely to the travel direction, ensures a good energy transfer between the two coils while, furthermore, the secondary coil can easily be connected with the second part with the aid of the elongated core.

A still further embodiment of the displacement device according to the invention is characterized in that the core is provided with three parallel legs and two bridge sections connecting the extremities of the legs.

Such a core, which may for instance be made of ferrite, ensures an optimal energy transfer between the two coils.

A still further embodiment of the displacement device according to the invention is characterized in that the secondary coil can be moved farther in relation to the primary coil in at least a direction that extends transversely to the travel direction.

In this manner, the second part can be moved in relation to the first part, both in the travel direction and in a direction which extends transversely to the travel direction, whereas the electrical energy transfer between the first and the second part requires only a single primary coil and a single secondary coil.

The invention will be further explained with reference to the drawings in which

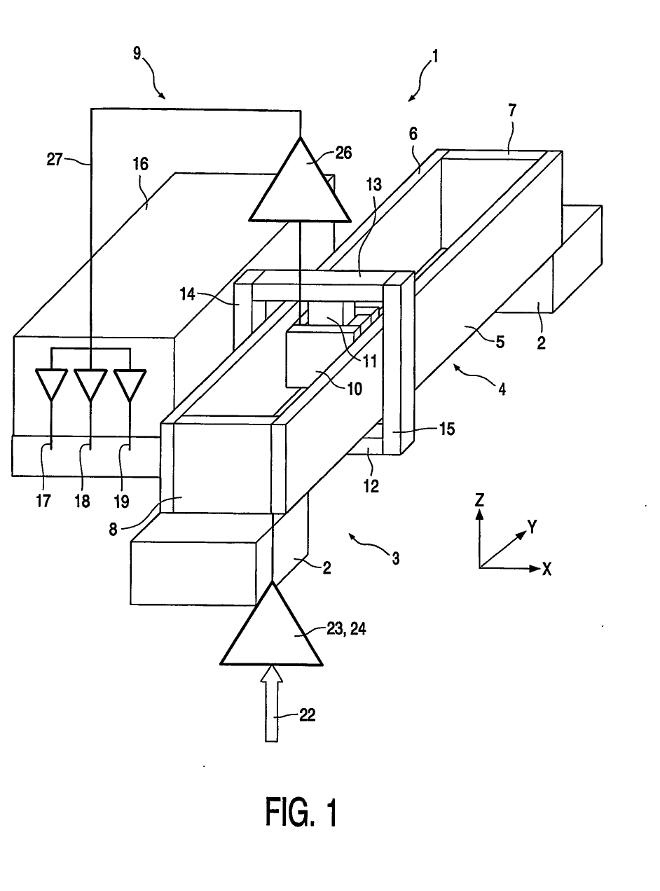

FIG. 1 shows a perspective view of a first embodiment of a displacement device according to the invention.

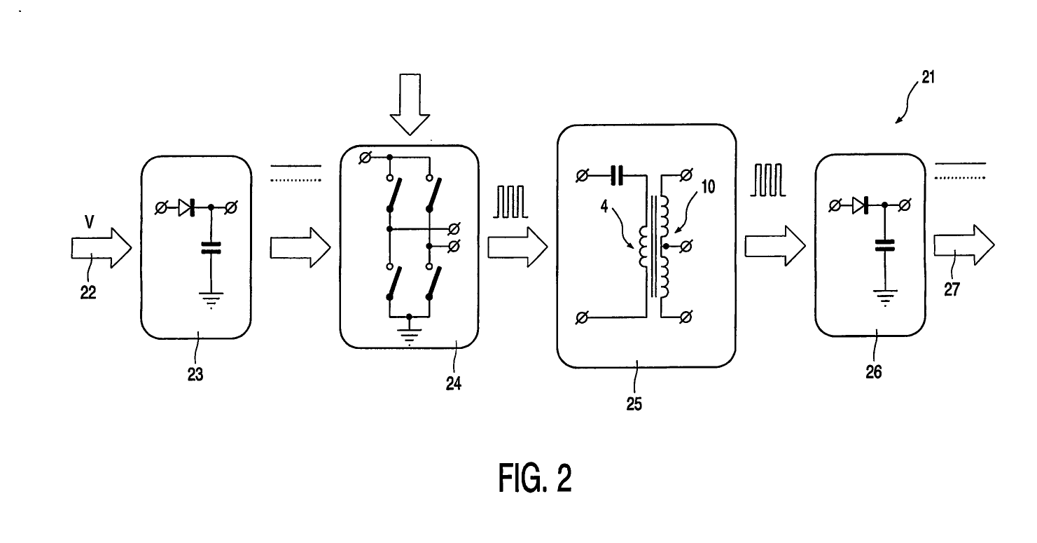

FIG. 2 shows a schematic view of an electrical circuit diagram of the displacement device represented in FIG. 1.

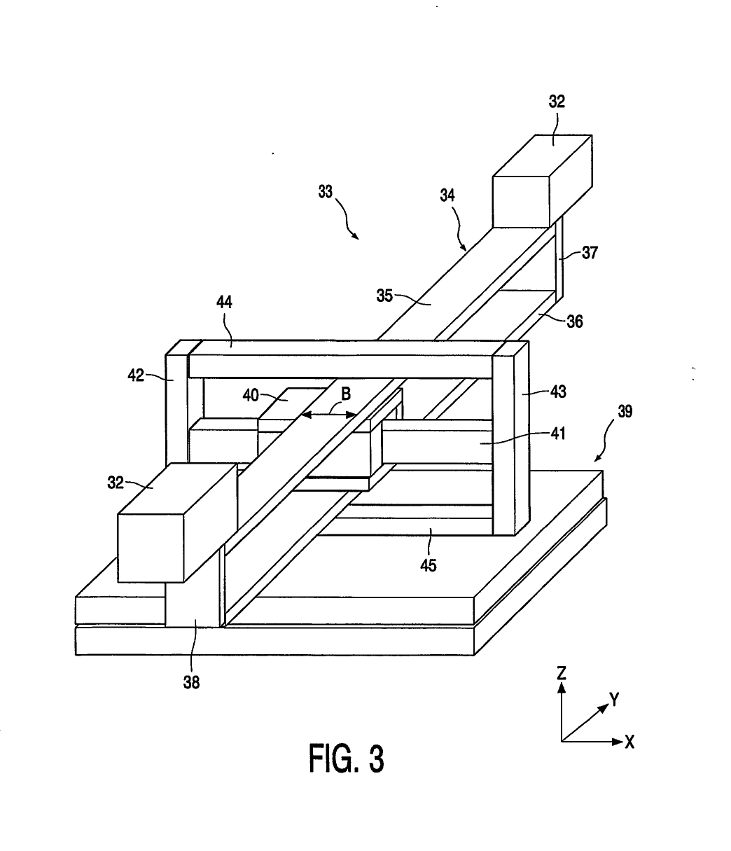

FIG. 3 shows a perspective view of a second embodiment of a displacement device according to the invention.

Corresponding parts in the Figures are indicated by like reference numerals.

FIG. 1 shows a displacement device 1 according to the invention, which is provided with a first stationary part 3 which comprises a frame 2. The frame 2 supports an elongated primary coil 4, which coil 4 is schematically shown by two parallel elements 5, 6 and elements 7,8 which extend between the two extremities of the elongated elements 5,6. The mutually connected elements 5-8 schematically show a number of windings of an electrically conducting wire. The relatively short elements 7,8 in relation to the elements 5,6 are each supported by a part of the frame 2. The displacement device 1 further comprises a second part 9 which can be moved in relation to the first part 3, which second part 9 is provided with an annular secondary coil 10 limited by the elements 5, 6, 7, 8. A leg 11 extends through the secondary coil 10 and its ends are connected to the bridge sections 12, 13 that extend transversely to the leg 11 whereby the bridge sections are mutually connected on both sides of the elements 5, 6 by the legs 14,15 which run parallel to the leg 11. The legs 11, 14, 15 and the bridge sections 12, 13 are made of ferrite and form a core cooperating with the coils 4, 10.

The leg 14 is rigidly connected with a frame 16 of the second part 9, which frame 16 is further provided with a number of electrically powered elements such as coils 17, 18, 19 of motors for instance (not represented) which permit the second part 9 to be moved in relation to the first part 3 in the travel direction indicated by the arrow Y and in the opposite direction thereof. In order to supply an electric current to the electrically driven elements 17, 18, 19, use can be made of the electrical current diagram represented in FIG. 2, in which an input alternating voltage 22 is supplied to an H-bridge 24 via a rectifier and a filter 23 which generates an approximately 100 to 200 kHz high-frequency direct voltage. In order to reduce the effects of flux loss in the system, the system is made resonant via a filter 25. The first coil 4 transfers electrical energy to the second coil 10. Subsequently, the voltage with a relatively high frequency, which is transferred to the second coil 10, is converted via a converter 26 to the appropriate direct voltage 27 suitable for the electrically driven elements. In this manner, electrical energy is transferred in a relatively simple manner from the first part 3 to the second part 9 without any mechanical contact between the first part 3 and the second part 9, which can be moved in relation to the first part 3. The distance between the elements 7, 8 of the primary coil 4 determines the distance across which the second part 9 can be moved in relation to the first part 3 in the direction indicated by the arrow Y.

FIG. 3 shows a second embodiment of a displacement device 31 according to the invention in which a first part 3³ comprises a frame 32 and a coil 34 supported by the frame 32. The coil 34 comprises, as does the coil 4, two elongated elements 35, 36 and two elements 37, 38 connecting the elongated elements 35, 36. The second part 39, which can be moved in relation to the first part 33, comprises a secondary coil 40 and a leg 41, which is connected with the legs 44,45 via the bridge sections 42, 43. The coil 40 distinguishes itself from the coil 10 in that the size of the coil 40 in a direction indicated by the arrow X and extending parallel to the leg 41, is approximately several times larger than the width B of the elements 35, 36. As a result of the electrical energy transferred to the secondary coil 40 by the primary coil 34 subsequently the second part 39 can be displaced in relation to the first part 33 in both the travel direction indicated by the arrow Y and in a direction extending transversely to the travel direction and indicated by the arrow X relative to the first part 33.

Obviously, a requirement is that motors are driven by means of the electrical energy transferred to the secondary coil 40 by means of the primary coil 34, which allows displacement in the directions indicated by the arrow Y and the arrow X and in the opposite directions thereto. If the distance in the direction indicated by the arrow Z between the coils 34 and 40 is only several millimeters, it is also possible to displace the second part 39 over this distance in the direction indicated by the arrow Z and in the opposite direction thereto by means of an appropriate actuator.

Instead of three parallel legs 11, 41, 14, 44, 15, 45 and the bridge sections 12, 42, 13, 43 connecting the legs, it is also possible either to omit one bridge section 12, 42, 13, 43 thereby forming an E-shaped structure with its central leg extended through the coil 40, or to use a different form of core. This facilitates the manufacture of the displacement device, however the device is less efficient and mechanically less stable.

The core can also be omitted.

The second part 9, 39 may also comprise control electronics to actuate the parts coupled to the second part.

1. A displacement device (1, 31) provided with a first part (3, 33) with a primary coil (4, 34) and a second part which can be moved in relation to the first part (9, 39), the second part (9, 39) being provided with a secondary coil (10, 40) which can be moved in relation to the primary coil (4, 34) and which is electrically connected to an electrically driven element, characterized in that at least one of the coils (4, 34, 10, 40) is an elongated coil which extends in a travel direction, in that the other coil (4, 34, 10, 40) can be moved in the travel direction in relation to the first coil (4, 34, 10, 40).

2. A displacement device (1, 31) according to claim 1, characterized in that the primary coil (4, 34) is the elongated coil and in that the secondary coil (10, 40) is located inside the primary coil (4, 34).

3. A displacement device (1, 31) according to claim 1 or 2, characterized in that a core (11, 41) extends through the coils (4, 34, 10, 40) transversely to the travel direction.

4. A displacement device (1, 31) according to claim 3, characterized in that the core is provided with three parallel legs (11, 14, 15; 41, 44, 45) and two bridge sections (12, 13; 42, 43) connecting the extremities of the legs.

5. A displacement device (1, 31) according to claim 4, characterized in that a middle leg (11, 41) extends through the two coils while the adjacent legs (14, 15; 44, 45) and the bridge sections (12, 13; 42, 43) are located around the two coils (4, 10; 34, 40).

6. A displacement device (1, 31) according to one of the preceding claims, characterized in that the secondary coil (10, 40) can be moved farther in relation to the primary coil (4, 34) in at least a direction that extends transversely to the travel direction.
